(19) United States
(12) Patent Application Publication
(10) Pub. No.: US 2012/0062024 A1
(43) Pub. Date: Mar. 15, 2012

(54) BRAKE BOOSTER SYSTEM FOR A VEHICLE BRAKE SYSTEM AND METHOD FOR OPERATING A VEHICLE BRAKE SYSTEM

(75) Inventor: Dirk Mahnkopf, Eglosheim (DE)

(73) Assignee: ROBERT BOSCH GMBH, Stuttgart (DE)

(21) Appl. No.: 13/257,421

(22) PCT Filed: Feb. 22, 2010
(86) PCT No.: PCT/EP10/52177

§ 371 Date: Sep. 19, 2011

(30) Foreign Application Priority Data
Apr. 20, 2009 (DE) 102009002489.1
Jan. 20, 2010 (DE) 102010001037.5

(51) Int. Cl. B60T 13/66; G06F 19/00

(52) U.S. Cl. 303/20; 701/70

(57) ABSTRACT

The invention relates to a brake booster system for a vehicle brake system, comprising a control device (34), which is designed to determine a boosting force (Fu) on the basis of provided first information with regard to a driver braking force (Ff) transmitted to a first piston (12) of the brake system, and comprising a first actuator device (30), which is designed to apply the boosting force (Fu) to a second piston (16) of the brake system. The control device (34) is further designed to determine, on the basis of provided second information with regard to an operating mode of the brake system, a compensating force (Fa) on a probable adjustment force which, in the operating mode, may be applied to the first piston (12) via the force/pressure conversion element (22), and a second actuator device (32) of the brake booster system is designed to apply this compensating force (Fa) to the first piston (12) of the brake system. The invention further relates to a method for operating a vehicle brake system.

### BACKGROUND OF THE INVENTION

The invention relates to a brake booster system for a vehicle brake system. The invention furthermore relates to a method for operating a vehicle brake system.

In order to allow a driver of a vehicle to actuate an actuating element of a brake system, e.g. a brake pedal, comfortably, a brake system generally has a brake booster. The brake booster is designed to provide a boosting force which is added to a driver braking force provided by the driver of the vehicle by actuation of the actuating element to bring about braking of at least one wheel. Suitable brake boosters are described in DE 10 2005 024 577 A1, DE 10057 557 A1 and DE 103 27 553 A1, for example.

FIGS. 1A and B shows schematic diagrams intended to illustrate one mode of operation of a conventional brake booster.

The brake system depicted schematically and in part in FIG. 1A has an actuating element 10, which is designed as a brake pedal, for example. By actuating the actuating element 10, the driver can apply a driver braking force Ff and a first adjustment travel s1 to an onward-leading brake system component, e.g. to an input piston 12 (see equivalent circuit diagram in FIG. 1B). In addition, the driver braking force Ff can be detected by means of an actuating element sensor system (not shown). The actuating element sensor system comprises a force sensor for measuring the driver braking force Ff, for example. As an alternative or supplementary measure to the force sensor, the actuating element sensor system can also have a displacement sensor for determining the first adjustment travel s1 and/or a differential travel between the first adjustment travel s1 and a second adjustment travel s2 (described below).

The brake system additionally has a brake booster 14. The brake booster 14 is designed to provide a boosting force Fu so that the driver does not have to apply all the force required to brake the vehicle as a driver braking force Ff.

The boosting force Fu provided by the brake booster 14 can be a function of the driver braking force Ff, of the first adjustment travel s1 and/or of the differential travel. The brake booster 14 transmits the boosting force Fu and a second adjustment travel s2 to a boosting piston 16, which is coupled, together with the input piston 12, to a coupling element, such as the reaction disk 18 shown. In the equivalent circuit diagram in FIG. 1B, the input piston 12 acts on a first point P1 and the boosting piston 16 acts on a second point P2 of the reaction disk 18. As a person skilled in the art will realize, points P1 and P2 correspond to areas of the reaction disk 18. For example, point P2 corresponds to an annular surface in the case of a tubular boosting piston 16.

The actuating element 10 and the brake booster 14 are arranged in the brake system in such a way that at least the driver braking force Ff and the boosting force Fu bring about a total braking force Fg and a third adjustment travel s3, which can be transmitted to a component arranged on the output side of the coupling element, such as the output piston 20. In this arrangement, the output piston 20 makes contact with the reaction disk 18 at a third point P3, more specifically at a corresponding surface.

In the case of a flexible reaction disk 18, said disk is deformed at a driver braking force Ff≠0 and/or a boosting force Fu≠0 (not shown in FIG. 1B). The capacity of the reaction disk 18 for bending can be given as elasticity e.

The output piston 20 is coupled to an adjustable component 21 of a force/pressure conversion element, e.g. a brake master cylinder 22. At least one brake circuit (not shown) filled with a braking medium and including at least one wheel brake cylinder is connected to the force/pressure conversion element. By modifying a brake pressure in the at least one wheel brake cylinder, the at least one associated wheel can be braked.

When the actuating element 10 of the conventional brake system illustrated by means of FIGS. 1A and 1B is actuated, however, the driver often feels an independently induced adjustment of the actuating element 10. In this context, an independently induced adjustment of the actuating element 10 is understood to mean a movement of the actuating element 10 which is not directly attributable to a movement, actuation and/or force applied to the actuating element 10 by the driver. The driver perceives the independently induced adjustment of the actuating element 10 as shuddering and/or as a counterstroke of the actuating element 10, for example. Such an independently induced adjustment of the actuating element 10 is very often confusing for the driver and thus considerably impairs the operating comfort of the actuating element 10.

It is therefore desirable to have a brake system with an actuating element that has improved operating comfort.

### SUMMARY OF THE INVENTION

The invention provides a brake booster system for a vehicle brake system and a method for operating a vehicle brake system.

The present invention is based on the insight that the independently induced adjustment of the actuating element of the brake system, which is confusing for the driver, is often attributable to an adjustment force applied to the first piston by a force/pressure conversion element. The force/pressure conversion element, to which at least one brake circuit of the brake system is coupled, can be a brake master cylinder of the brake system. The adjustment force is triggered when a volume of braking medium is displaced from the at least one brake circuit into the force/pressure conversion element, for example. Such displacement of a volume of braking medium occurs, in particular, when there is a reduction in the total braking force composed of the driver braking force and the boosting force, when a pump in a brake circuit is activated, when a valve is operated and/or when there is inlet valve activation. Such an operating mode of the brake system can be detected from the provided second information.

The present invention is furthermore based on the insight that it is possible to apply a specified compensating force to the first piston of the brake system by means of a second actuator device.

In particular, the specified compensating force counteracts the (probable) adjustment force. In this way, the present invention prevents an independently induced adjustment of the actuating element and thus improves operating comfort for the driver. In particular, application of the compensating force by the second actuator device leads to improved pedal feel for the driver.

The term “first piston” is intended to mean a device for mechanical/hydraulic coupling of the actuating element to the force/pressure conversion element. In a corresponding fashion, the term “second piston” is intended to mean a device for mechanical/hydraulic coupling of the first actuator device to the force/pressure conversion element. Thus the present invention is not limited to design of the first piston and/or the second piston in the narrower sense of the term. The first piston and/or the second piston are/is preferably designed in such a way that they allow the driver to make a direct braking input into at least one braking circuit via the force/pressure conversion element. In particular, the terms “first piston” and/or “second piston” can also be understood to mean a device for hydraulic force transmission.

The brake booster system described here and the corresponding method can be employed in an inexpensive brake system of simple construction. In general, no additional brake system sensors will be required in order to use the brake booster system and to carry out the method. Inexpensive application of the present invention is thus ensured.

In particular, the brake booster system according to the invention can be produced using at least one conventional brake booster as the actuator device. The operating advantages of a conventional brake booster can thus also be ensured in the brake booster system.

In a preferred embodiment, the provided second information comprises braking torque information relating to a time change in a second braking torque, which can be applied to the at least one wheel in addition to the first braking torque. As a supplementary measure, the control device can additionally be designed to modify the boosting force, on the basis of the braking torque information, by a difference corresponding to the time change in the second braking torque. If there is an increase in the second braking torque, for example, the boosting force is reduced by a difference corresponding to the increase. If there is a decrease in the second braking torque, the boosting force can be increased in a corresponding manner by a difference corresponding to the decrease. In this way, it is easy, in particular, to effect maintenance of a braking torque which is constant with respect to time composed of the first braking torque and the second braking torque, despite the time change in the second braking torque.

Despite uniform actuation of the actuating element of the brake system by the driver, there are often fluctuations in the overall retardation of the vehicle with conventional systems. These fluctuations are often attributable to an increase or a reduction in the second braking torque. Such a situation occurs especially if a generator torque for charging a vehicle battery is activated while the vehicle is being braked.

According to the prior art, blending in the second braking torque can generally be accomplished only by decoupling the actuating element from the at least one brake circuit of the brake system and by using an additional actuator component to provide the braking force that would otherwise be applied by the driver by actuation of the actuating element. However, such decoupling of the actuating element from the at least one brake circuit is associated with the risk that, if the actuator component fails, the driver will no longer be able to make a direct braking input into the at least one brake circuit and make up for the failed actuator component. Decoupling the actuating element from the at least one brake circuit thus has the effect of reducing the safety of the brake system.

In contrast, the embodiment described above can also be employed where there is mechanical coupling between the actuating element and the at least one brake circuit. Thus, in addition to the possibility of blending in the second braking torque, good brake system safety is also ensured.

In an advantageous development, the control device is additionally designed to specify, on the basis of the braking torque information, the compensating force relative to a probable adjustment force of the force/pressure conversion element on the first piston, which corresponds to the difference. Thus the disadvantage which often occurs in a conventional brake system that blending in the second braking torque leads to a change in the volume uptake of the brake system and hence to a movement of the actuating element can be eliminated. This means that not only is the total braking torque adapted to the time change in the second braking torque but that there is also an assurance that the actuating element will not carry out any independently induced movement during blending. Thus the driver does not notice the blending in of the second braking torque from an independently induced movement of the actuating element either. This results in an additional improvement in the operating comfort of the actuating element.

Furthermore, the control device can additionally be designed to specify the boosting force on the additional basis of the specified compensating force. For example, the specified compensating force is subtracted from the boosting force. The provision of the compensating force thus does not cause any additional braking torque but merely a leverage which compensates for a change in the pressure and/or volume of the force/pressure conversion element during the blending in of the second braking torque. This provides the possibility of an additional improvement in the pedal feel.

The advantages described in the paragraphs above are also ensured in a brake system with a brake booster system of this kind and in a vehicle fitted with a corresponding brake system.

Furthermore, the advantages described above can also be achieved by means of a corresponding method for operating a vehicle brake system.

In addition, the present invention ensures monitoring of the brake system, in particular of the reaction disk of the brake system. It is possible in this context for calibration when stopped and/or compensation of aging processes to be carried out.

### BRIEF DESCRIPTION OF THE DRAWINGS

Further features and advantages of the present invention are explained below with reference to the figures, of which:

FIGS. 1A and B show schematic diagrams intended to illustrate one mode of operation of a conventional brake booster;

FIG. 2 shows a schematic diagram of one embodiment of the brake booster system;

FIGS. 3A to 3E show four schematic diagrams and a coordinate system intended to illustrate one mode of operation of the brake booster system in FIG. 2; and

FIG. 4 shows a flow diagram intended to illustrate one embodiment of the method for operating a vehicle brake system.

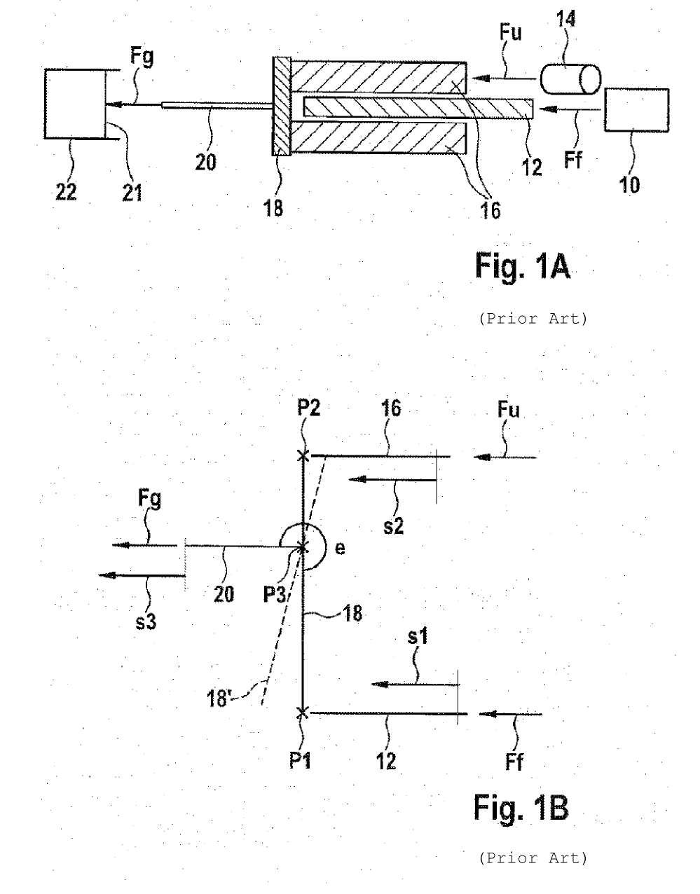

### DETAILED DESCRIPTION

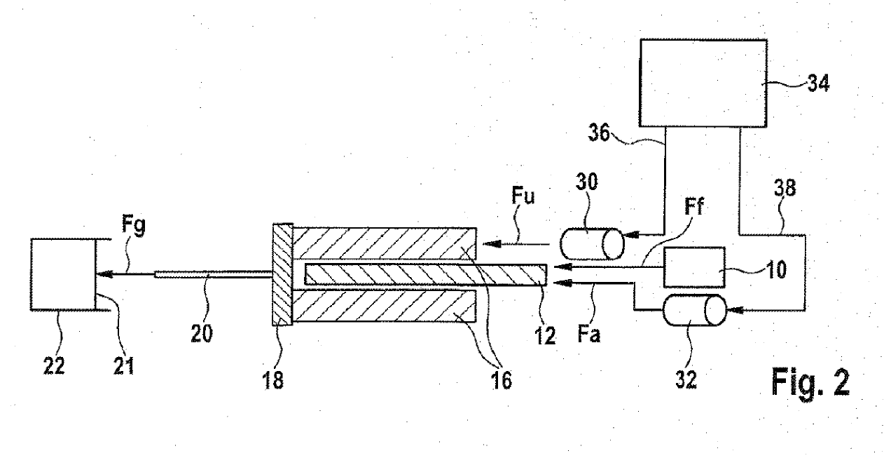

FIG. 2 shows a schematic diagram of one embodiment of the brake booster system.

The brake booster system illustrated is arranged on a brake system having the components 10, 12 and 16 to 22 already described. The actuating element 10 of the brake system can be a brake pedal, for example. At least one brake circuit is connected to the force/pressure conversion element, which is designed as a brake master cylinder 22 and has the adjustable component 21.

The applicability of the brake booster system described below is not limited to a particular embodiment of a brake circuit filled with a brake gas or a brake fluid. For example, various alternative possibilities in terms of volume management in the brake system are conceivable. Since these are obvious for a person skilled in the art from the following descriptions, these are not explored in detail here.

Attention is drawn to the fact that the applicability of the brake booster system is also not limited to the coupling mechanism illustrated, consisting of the input piston 12, the boosting piston 16 (which may be tubular, for example) and the reaction disk 18. For example, it is also possible for some other brake booster/actuating element/coupling element to be used to add the driver braking force Ff and the boosting force Fu to the total braking force Fg instead of the reaction disk 18. At the same time, the total braking force Fg can also comprise at least one additional force, which will be explained below.

The brake booster system comprises at least one first actuator device 30, one second actuator device 32 and one control device 34, the operation of which will be explained in greater detail below:

The control device 34 is designed to specify a(n advantageous) boosting force Fu on the basis of provided first information relating to the driver braking force Ff transmitted to the input piston 12 when the actuating element 10 is actuated. Once the (advantageous) boosting force Fu has been specified, the control device 34 outputs a corresponding first control signal 36 to the first actuator device 30.

The boosting force Fu is preferably specified as a function of the driver braking force Ff and/or the first adjustment travel s1 (not shown) of the actuating element 10. In this context, the driver braking force Ff and/or the first adjustment travel s1 of the actuating element 10 (or input piston 12) can be determined by means of an actuating element sensor system (not shown) and then provided to the control device 34 as first information. A suitable actuating element sensor system preferably comprises a force sensor and/or a displacement sensor, e.g. a pedal travel sensor. The actuating element sensor system can be a subunit of the control device 34. The actuating element sensor system can likewise be arranged separately from the control device 34 and, in particular, the first information can be provided to the control device 34 via a vehicle bus.

The first actuator device is designed to receive the first control signal 36 and to apply the boosting force Fu corresponding to the first control signal 36 received to the boosting piston 16. This ensures that the total braking force Fg composed of at least the driver braking force Ff and the boosting force Fu is transmitted to the brake master cylinder 22 acting as the force/pressure conversion element. The force/pressure conversion element (the brake master cylinder 22) is designed in such a way that a brake pressure corresponding to the total braking force Fg is transmitted to the at least one coupled brake circuit of the brake system. This brake pressure acts as a hydraulic braking torque on at least one associated wheel via the at least one wheel brake cylinder of the at least one coupled brake circuit.

The provision of the boosting force Fu ensures that the driver has to apply a lower driver braking force Ff to brake the vehicle. This makes it easier for the driver to brake the vehicle in terms of force. The use of the brake booster system thus improves the operating comfort of the brake system.

The control device 34 is additionally designed to specify a compensating force Fa on the basis of provided second information relating to an operating mode of the brake system. In this case, the compensating force Fa is specified in such a way that the compensating force Fa counteracts a probable adjustment force which, in the operating mode, may be applied to the input piston 12 by the brake master cylinder in accordance with the second information. The term “probable adjustment force” is understood to mean a force which will occur with a high probability in the operating mode. In this case, the probable adjustment force is applied to the input piston 12 in such a way that the input piston 12 is adjusted. The probable adjustment force is provided by means of a change in the pressure in the force/pressure conversion element/brake master cylinder 22, by means of a change in the volume of the force/pressure conversion element/brake master cylinder 22 and/or by means of an adjustment of the adjustable component 21.

After the compensating force Fa has been specified, the control device 34 outputs a corresponding second control signal 38 to the second actuator device 32. The second actuator device 32 is designed to receive the second control signal 38 and to apply a corresponding compensating force Fa to the input piston 12.

This ensures that the input piston 12 is not adjusted by the adjustment force of the brake master cylinder 22 on the input piston 12 which is to be expected in the operating mode. This makes it possible to prevent a change in pressure and/or volume in the brake master cylinder 22, which customarily leads to an independently induced adjustment of the input piston 12 and of the actuating element 10. It is therefore possible, for example, to counteract activation of a pump, operation of a valve and/or displacement of a volume of braking medium between the brake master cylinder 22 and the at least one brake circuit (not shown) by means of the brake booster system in such a way that there is no independently induced movement of the actuating element 10.

For example, the provided second information comprises braking torque information relating to a time change in an additional braking torque, which is applied to at least one wheel of the vehicle in addition to the hydraulic braking torque. The second information relating to the operating mode of the brake system is the braking torque information relating to an activation, a deactivation, an increase and/or a reduction of the additional braking torque, for example. As will be described more fully below, the control device 34 can in this case be designed to blend in the additional braking torque and, at the same time, to prevent an independently induced adjustment of the actuating element 10 owing to the blending in of the additional braking torque. The additional braking torque can advantageously be a generator braking torque and/or a drag torque.

The actuator devices 30 and 32 can be an electromechanical brake booster, an electric brake booster, a vacuum brake booster and/or a hydraulic brake booster, for example. It is, of course, also possible for more than two brake boosters to be used as actuator devices 30 and 32. The two actuator devices 30 and 32 can likewise be subunits of an overall brake booster. If appropriate, the control device 34 can likewise be a subunit of the overall brake booster. It is therefore obvious to a person skilled in the art that the applicability of the brake booster system is not limited to a particular type of (overall) brake booster as actuator device 30 or 32.

Attention is drawn to the fact here that the actuator devices 30 or 32 can be activated separately. This means, for example, that the forces Fu and Fa provided by the actuator devices 30 or 32 can be specified and provided independently of one another.

The second actuator device 32 can also be designed to provide/bring about the compensating force Fa as an additional friction force during an adjustment of the input piston 12. Such a design of the second actuator device 32 is easy to implement. In this case, the input piston 12 and the second actuator device 32 can be designed as component parts of a self-energizing brake system.

In a preferred embodiment, the control device 34 is designed to specify the compensating force Fa in such a way that the adjustment force which is probable in the operating mode is compensated by the compensating force Fa. It is thereby reliably ensured that the driver does not notice any independently induced adjustment when actuating the actuating element 10.

In an advantageous development, the control device 34 is additionally designed to specify the boosting force Fu on the additional basis of the braking torque information. In this case, the boosting force Fu is adapted with respect to an activation, a deactivation, an increase and/or a reduction of the additional braking torque.

In particular, a time change in the additional braking torque can bring about respecification of the boosting force Fu by a difference corresponding to the time change. The respecification of the boosting force Fu is preferably carried out in such a way that a total braking torque composed of the hydraulic braking torque and the additional braking torque is held constant despite the time change in the additional braking torque.

In addition, the control device 34 can be designed to specify the compensating force Fa in such a way that the compensating force Fa counteracts a probable adjustment force which to the difference by which the boosting force Fu is respecified. In this case, the compensating force Fa counteracts a probable adjustment force, which is attributable to the fact that the boosting force Fu altered by the difference brings about a change in the total braking force Fg by the difference and hence a change in the hydraulic braking torque. The change in the hydraulic braking torque generally leads to a change in the pressure within the brake master cylinder 22 and hence to a displacement of the adjustable component 21 of the brake master cylinder 22. There is thus a relation between the difference by which the boosting force Fu is respecified and the probable adjustment force. By means of the embodiment described here, however, the disadvantages which usually result from this relation can be eliminated in a simple manner. Here, the compensating force Fa preferably compensates the probable adjustment force corresponding to the difference.

The control device 34 can furthermore be designed to adapt the boosting force Fu to the specified compensating force Fa after specification of the compensating force Fa. After specification of the compensating force Fa, the control device 34 advantageously specifies a new boosting force Fu, which differs from the previously applicable boosting force Fu by the compensating force Fa. Thus, specifying the compensating force Fa does not result in any change in the total braking force Fg or in the hydraulic braking torque.

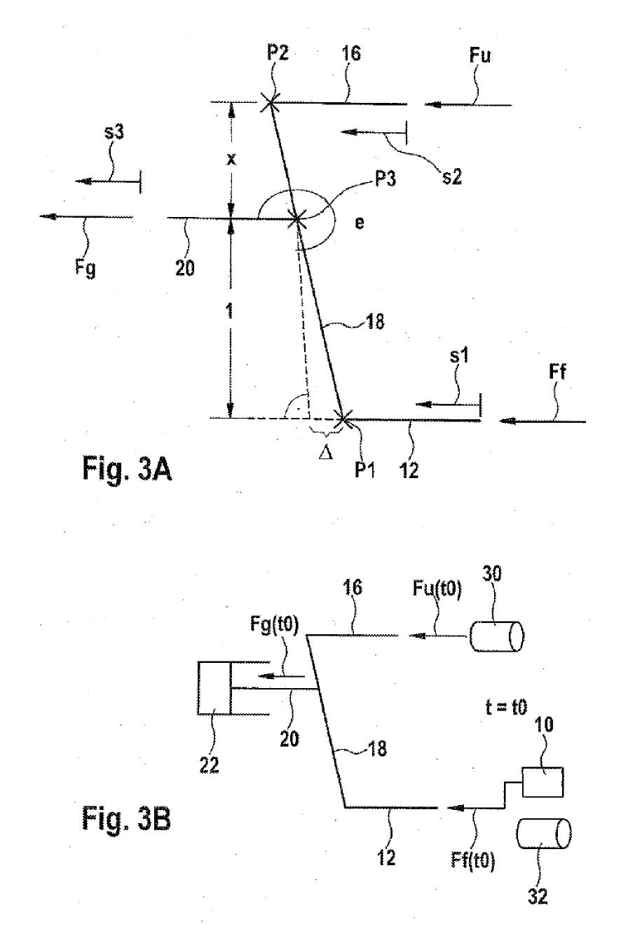

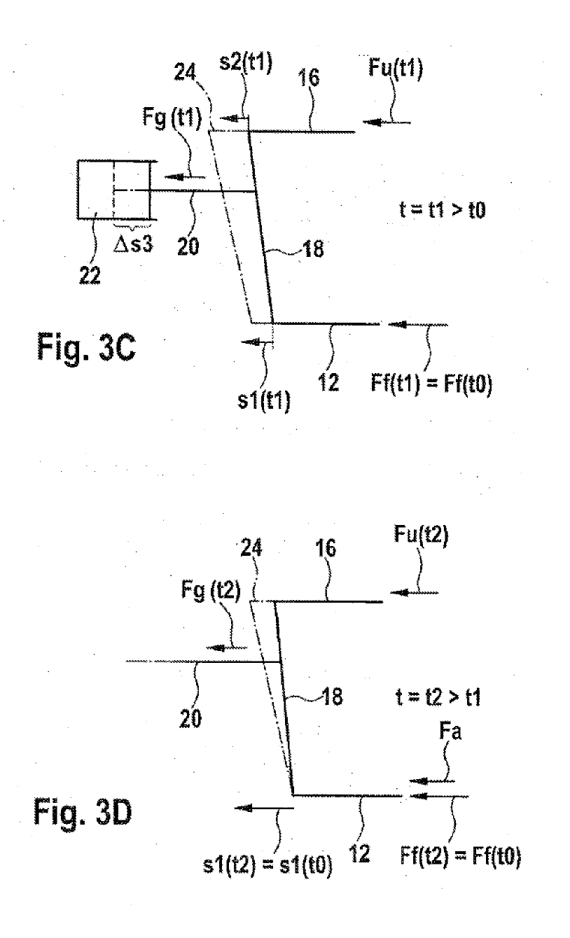

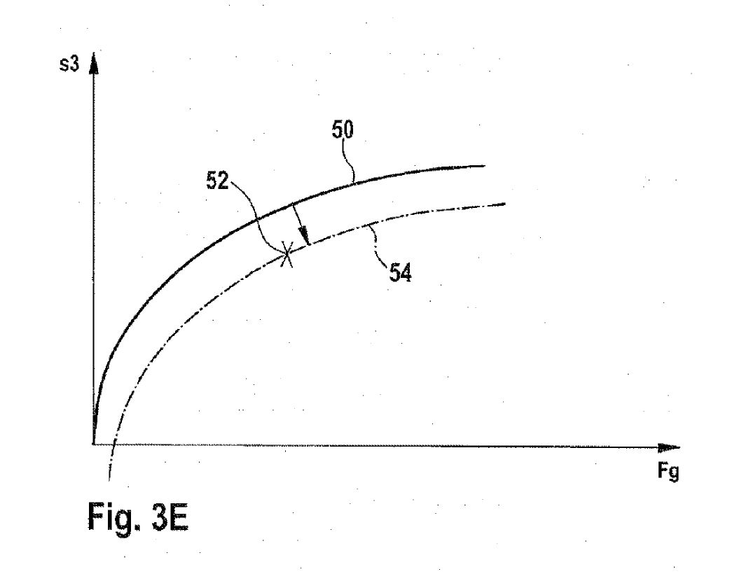

The operation of the brake booster system will be explained in greater detail below with reference to FIGS. 3A to 3E.

FIGS. 3A to 3E show four schematic diagrams and a coordinate system intended to illustrate the one mode of operation of the brake booster system in FIG. 2.

FIG. 3A shows an equivalent model intended to represent a deformation of the reaction disk 18 at a driver braking force Ff≠0 and a boosting force Fu≠0. For the sake of greater clarity, the compensating force Fa is equal to zero in FIG. 3A. As a person skilled in the art will realize, one other force can contribute to the total braking force Fg in addition to the driver braking force Ff, the boosting force Fu and the compensating force Fa. However, this case is not considered below for the sake of greater clarity.

The reaction disk 18 can represent a “controlled elasticity”. Points P1 to P3 correspond to areas on the reaction disk 18. A quotient x indicates the ratio of a first distance between points P2 and P3 to a second distance between points P3 and P1. If point P1 is adjusted by a bending variable Δ of the reaction disk 18 in relation to point P3, then:

s1=s3+Δ (Eq. 1)

Adjustment of the output piston 20 by the third adjustment travel s3 thus generally brings about adjustment of the input piston 12 and of the actuating element 10 by the first adjustment travel s1. A differential displacement sensor (not shown) is preferably arranged on the reaction disk 18 to directly measure the bending variable Δ.

From the moment equilibrium at the reaction disk 18, the following is obtained:

Δ*e=Ff−x*Fu (Eq. 2)

By substituting equation (Eq. 2) in equation (Eq. 1), the following is therefore obtained:

s1=s3+(Ff−x*Fu)/e (Eq. 3)

The relation expressed by equation (Eq. 3) between the first adjustment travel s1 of the actuating element 10 and the third adjustment travel s3 of the output piston 20 often leads in conventional setups to impairment of the actuating comfort of the actuating element 10. Owing to the relation, a change in the pressure in the force/pressure conversion element (the brake master cylinder 22) and/or in the brake circuit can lead in a conventional setup to an independently induced adjustment of the actuating element 10, for example, which is confusing for the driver. This disadvantage of a conventional setup can be eliminated by means of the brake booster system.

FIG. 3B shows an equivalent model of the brake system having the brake booster system at a time t0. For the sake of clarity, it is assumed below that the driver applies a driver braking force Ff which is constant with respect to time and a first adjustment travel s1 which is constant with respect to time to the actuating element 10 from time t0. A boosting force Fu which is constant with respect to time and a second adjustment travel s2 which is constant with respect to time is accordingly provided by the first actuator device 30 at time t0. The boosting force Fu and the second adjustment travel s2 are known from the activation of the first actuator device 30 by the control device 34. At time t0, the compensating force Fa is equal to zero.

Attention is drawn to the fact here that the application of the brake booster system described here is not limited to actuation of the actuating element 10 by the driver in a manner which is constant with respect to time. The description of the operation of the brake booster system with actuation of the actuating element 10 in a manner which is constant with respect to time is used merely for greater clarity.

At time t0, there is thus a constant hydraulic braking torque Mh acting on at least one wheel associated with the brake circuit, this braking torque being the product of a brake pressure p (proportional to the total braking force Fg) provided by the brake master cylinder 22 and a constant C:

Mh=C*p (Eq. 4)

At a time t*>t0, an additional braking torque Mz unequal to zero is activated. However, the application of the brake booster system described below can also be carried out when the additional braking torque Mz is increased, reduced or deactivated. The additional braking torque Mz is a generator braking torque, for example. However, it is also possible for some other additional braking torque Mz to be blended in by means of the brake booster system instead of a generator braking torque.

At time t*, the total braking torque Mg(t*) is thus composed of the hydraulic braking torque Mh and the additional braking torque Mz:

Mg(t*)=Mh(t*)+Mz(t*) (Eq. 5)

Despite the additional braking torque Mz(t*)≠0, it is desirable to maintain a constant total braking torque Mg when the driver actuates the actuating element 10 in a constant manner, giving:

Mg(t>t*)=Mg(t0) (Eq. 6)

The brake booster system having components 30 to 34 is preferably designed to ensure that the total braking torque Mg is held constant despite the activation of the additional braking torque Mz (t>t0).

FIG. 3C shows an equivalent model at time t1>t*. Between time t* and t1, the control device 34 has specified a new boosting force Fu on the basis of the additional braking torque Mz. Here, the following equation applies for a specified difference D between the boosting force Fu(t0) at time t0 and the boosting force Fu(t1) at time t1:

Fu(t1)=Fu(t0)+D (Eq. 7)

If the driver braking force Ff remains constant, the following therefore applies:

Fg(t1)=Fg(t0)+D (Eq. 8)

The difference D preferably compensates the additional braking torque Mz, with the result that equation (Eq. 6) applies and the overall retardation of the vehicle at time t1 corresponds to the retardation of the vehicle at time t0:

D=Mz*A/C, (Eq. 9)

where A corresponds to an area of the brake master cylinder 22, or

D=α×Mz, (Eq. 10)

where α is a constant of the brake system.

The driver is thus not confused by an impairment in the retardation of the vehicle when the additional braking torque Mz is activated.

Admittedly, a change in the boosting force Fu/the total braking force Fg by the difference D causes a displacement of a volume of braking medium between the brake master cylinder 22 and the at least one brake circuit of the brake system. This displacement changes the third adjustment travel s3 of the output piston 20 by a travel difference Δs3. There can also be a corresponding alteration in the position of the reaction disk 18, as illustrated by the dashed line 24, which corresponds to the position of the reaction disk 18 at time t0. The altered position of the reaction disk 18 can furthermore alter the position of the input piston 12 and hence bring about an independently induced adjustment of the actuating element 10. Such an independently induced adjustment of the actuating element 10 is usually very confusing for the driver.

However, the brake booster system described here has two independently controllable actuator devices 30 and 32. These two actuator devices 30 and 32 provide two degrees of freedom, making it possible, in addition to blending in the additional braking torque Mz by means of the first actuator device 30, to activate the second actuator device 32 in such a way that a (probable) adjustment force attributable to the change in the boosting force Fu/total braking force Fg by the difference D and a correspondingly changed hydraulic braking torque is counteracted.

FIG. 3D shows the equivalent model at time t2 after the provision of the compensating force Fa, which counteracts the probable adjustment force, and adaptation of the boosting force Fu to the compensating force Fa provided. The compensating force Fa is preferably specified in such a way that the following applies for the first adjustment travel s1:

s1(t2)=s1(t0), where (Eq. 11)

Ff(t2)=Ff(t1)=Ff(t0) (Eq. 12)

At time t2, the first adjustment travel s l (t2) is thus once again identical with the first adjustment travel s1(t0) at time t0. It is thus possible to ensure that the displacement of the volume of braking medium between the brake master cylinder and the at least one brake circuit, which is associated with the blending in of the additional braking torque, does not cause any adjusting movement of the actuating element 10.

To ensure that counteraction of the probable adjustment force is not associated with an altered overall retardation of the vehicle, it is advantageous if:

Fg(t2)=Fg(t1), where (Eq. 13)

Fg(t2)=Ff(t2)+Fu(t2)+Fa(t2) (Eq. 14)

The hydraulic braking torque Mh corresponding to the total braking force Fg is thus also held constant.

In order to ensure equation (Eq. 13), the boosting force Fu can be adapted to the compensating force Fa provided by the second actuator device 32. In this case:

Fu(t2)=Fu(t1)−Fa=Fu(t0)+D−Fa (Eq. 15)

From time t1, therefore, an additional free moment (torque) is applied to the reaction disk 18. This is accomplished by modifying the forces Fu and Fa applied by the two actuator devices 30 and 32 in such a way that the total braking force Fg composed of at least the driver braking force Ff, the boosting force Fu and the compensating force Fa remains constant with respect to time from time t1. The change in the forces Fu and Fa preferably takes place in accordance with the quotient x.

As a person skilled in the art will realize, the holding constant of the retardation of the vehicle and the holding constant of the first adjustment travel s1 are decoupled and carried out independently of one another in the method described here. In particular, the quotient x can be specified in such a way as to give an advantageous leverage ratio.

The torque of the reaction disk 18 brought about in this way thus has no effect on the hydraulic braking torque Mh. The torque merely causes an additional deformation of the reaction disk 18. This deformation can be used to set the first adjustment travel s1(t2) of the input piston 12 at time t2 in such a way that it is equal to the adjustment travel s1(t0) at time t0 before the alteration of the additional braking torque Mz with respect to time. In this way, it is possible to ensure that the driver does not feel any independently induced adjustment of the actuating system 10 and thus does not notice anything of the additional braking torque Mz.

The bending variable Δ can be modifiable in such a way that it becomes negative. In this way, even a relatively large volume of braking medium displaced between the brake master cylinder and the at least one brake circuit can be compensated in such a way that the driver will not notice any reactive effects on a position of the actuating element 10.

As a person skilled in the art will realize, the method steps described in the above paragraphs can be carried out with a rapidity such that the time interval between times t0 and t2 approaches zero. This means that the first adjustment travel s1 will be perceived as constant with respect to time by the driver.

To illustrate the operation of the brake booster system, a numerical example is given below:

A small car has a reaction disk 18 with an elasticity e of 1.8×10⁻⁵ N/m and a quotient x of 0.25, for example. (This quotient x corresponds to a multiplication factor of the first actuator device 30 of 5.) The pedal transmission ratio is 3.15, for example. The brake master cylinder 22 can have a diameter of 20.62 mm.

In the example described here, the driver stipulates a total braking torque equal to an overall retardation of 0.3 g by actuating an actuating element 10 designed as a brake pedal. This corresponds to a pedal force of 53.5 N and a pedal travel of 28.4 mm. The master cylinder pressure is 19 bar.

The boosting force Fu is thus 580.6 N. The bending variable Δ is accordingly within a range of from −0.5 to −1 mm. A value of −0.5 mm will be assumed below. According to (Eq. 2), the third adjustment travel is 8.5 mm.

At time t*, an additional braking torque corresponding to a retardation of 0.15 g is activated. The hydraulic braking torque Mh is therefore reduced to a value equal to a retardation of 0.15 g by time t1. This is accomplished by adapting the boosting force Fu provided.

To blend in the additional braking torque Mz unequal to a retardation of 0.15 g, the boosting force of 580.6 N applied by the first actuator device 30 is reduced to 42 N. To ensure that the first adjustment travel remains constant with respect to time, the bending variable Δ is readjusted to 1.4 mm. (At 1.4 mm, the bending variable Δ is within the range of possible values.) The compensating force Fa provided by the second actuator device 32 is 167 N.

A larger brake pressure gives rise to a larger additional braking torque Mz that can be blended in since the volume uptake per bar decreases as the pressure rises and the pedal travel to be eliminated thus becomes smaller.

Two possible control strategies for specifying a suitable boosting force Fa are described below:

In a first control strategy, the blending in of the additional braking torque Mz is followed by calculation of the (advantageous) bending variable Δ from the known variables e, Ff, x and Fu by means of equation (Eq. 2). The (advantageous) bending variable Δ is set by means of the first actuator device 30. Accordingly, the compensating force Fa, which is provided by the second actuator device, is controlled in such a way that the first adjustment travel s1 is given by s1(t2)=s1(t0).

This control strategy is advantageous if the brake system already has a sensor system which is designed to determine the bending variable Δ or corresponding information on the reaction disk 18. Since the boosting force Fu and the second adjustment travel s2 are already known from the activation of the first actuator device 30, the first control strategy can in this case be carried out without the need for an additional sensor.

The second control strategy, which is described below, is advantageous inasmuch as the driver requirement for retardation is determined by measurement of the first adjustment travel sl. Since both the second adjustment travel s2 and the applied boosting force Fu are known from the control of the first actuator device 30, the driver braking force Ff can be calculated in accordance with (Eq. 2) with the aid of a measured bending variable Δ. The total braking force Fg for Fa=0 (i.e. before the activation of the compensating force Fa) is thus also known from:

Fg=Ff+Fu (Eq. 16)

If the boosting force Fu is altered by a difference D≠0, the associated adjustment variable Δs3 can be determined with the aid of a force/displacement characteristic of the brake system, for which the following applies:

Δs3=s3(t0)−s3(t1) (Eq. 17)

The force/displacement characteristic can be stored in the control device 34, for example.

Thus all the required information is available for specifying the compensating force Fa in such a way that the first adjustment travel s1(t2) up to time t2 is preferably set to the first adjustment travel s1(t0) set at time t0. The further calculation steps are obvious to a person skilled in the art from the explanations above.

The second control strategy has the advantage that modification of the first adjustment travel s1 can be carried out by means of open-loop control, rather than closed-loop control. In this way, it is possible to suppress fluctuations during a control cycle.

A fixed value is preferably stipulated for the compensating force Fa of the second actuator device 32, while closed-loop control is used with respect to the first actuator device 30 to adjust the bending variable Δ to an advantageous value. This ensures that braking force multiplication continues to take place if the driver continues to apply a force to the actuating element 10.

FIG. 3E shows a coordinate system with a suitable force/displacement characteristic 50. Here, the abscissa corresponds to a total braking force Fg. The ordinate indicates the associated third adjustment travel s3.

During the use of the brake booster system, aging processes can lead to a displacement of the force/displacement characteristic 50. Such aging processes are attributable to damping or friction, for example.

Aging processes can be compensated by determining measuring points 52 for pairs of values of the third adjustment travel s3 and the total braking force Fg during the use of the brake booster system. A measuring point 52 is preferably specified when there is a rise in the additional braking torque Mz. Using at least one measuring point 52 specified in this way, it is possible to specify a recalibrated force/displacement characteristic 54. The control device 34 can thus be designed to specify the recalibrated force/displacement characteristic 54 by means of at least one measuring point 52. The force/displacement characteristic 50 is shifted on the basis of at least one specified measuring point 52, for example. In this way, it is possible to compensate aging processes.

Since the elasticity e of the reaction disk 18 is likewise subject to aging, it is advantageous to respecify the elasticity e during the use of the brake booster system. This can be accomplished, for example, by determining the deformation of the reaction disk 18 resulting from the driver braking force Ff when the actuating element is actuated while the vehicle is stationary by activating the first actuator device 30.

In particular, it is advantageous if the driver does not increase the driver braking force Ff during such a measurement. This can be verified by determining the first adjustment travel s1(ta) at the start of measurement and the first adjustment travel s1(te) at the end of measurement. Provided the driver does not increase the driver braking force Ff during measurement, the following equation applies:

s1(te)−s1(ta)=s3(te)−s3(ta)−x(Fu(te)−Fu(ta))/e (Eq. 18)

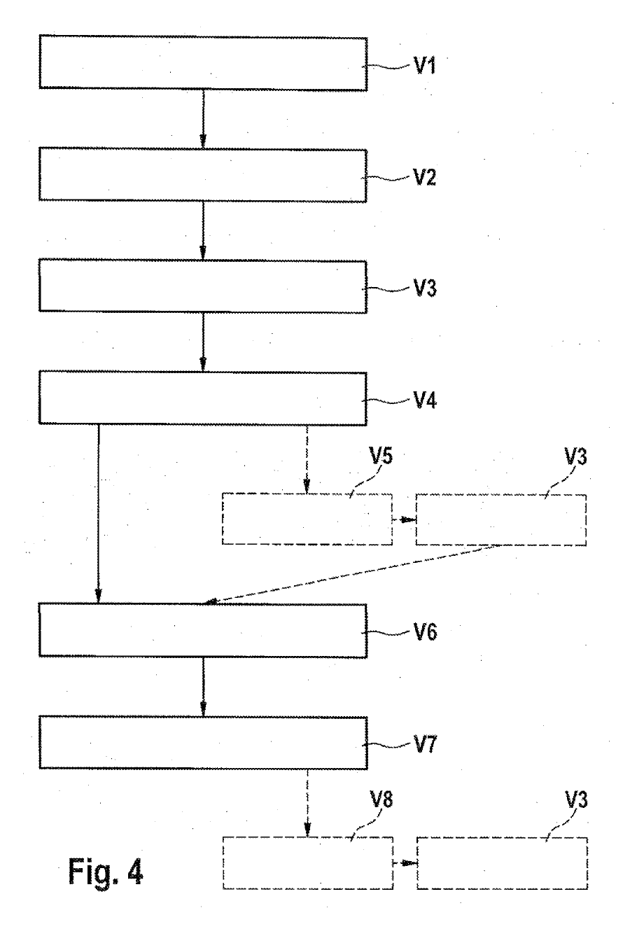

FIG. 4 shows a flow diagram intended to illustrate an embodiment of the method for operating a vehicle brake system.

In a method step V1, first information relating to a driver braking force transmitted to a first piston of the brake system when an actuating element of the brake system is actuated by a driver of the vehicle is communicated. The first information can comprise a driver braking force applied to the first piston, a first adjustment travel of the first piston and/or a differential travel, for example. In a method step V2, a boosting force is then specified on the basis of the first information determined. The specified boosting force is preferably a function of the driver braking force and/or of the first adjustment travel.

In a further method step V3, a first actuator device is activated to apply the specified boosting force to a second piston of the brake system. In this case, a total braking force composed of at least the driver braking force and the boosting force is transmitted to a force/pressure conversion element of the brake system. At least one brake circuit is coupled to the force/pressure conversion element. A brake pressure corresponding to the total braking force is applied as a first braking torque to at least one wheel of the vehicle. The force/pressure conversion element is a brake master cylinder, for example.

During method steps V1 to V3 or subsequently, second information relating to an operating mode of the brake system is determined (method step V4). Braking torque information relating to a time change in a second braking torque, which can be applied to at least one wheel of the vehicle in addition to the first braking torque (hydraulic braking torque), is determined as second information, for example.

In a method step V5, the boosting force can optionally be respecified on the additional basis of the braking torque information. This can be accomplished by modifying the boosting force, when there is a time change in the second braking torque, by a difference corresponding to the time change in the second braking torque. Method step V3 can then be carried out again. In this way, it is possible to ensure that a total vehicle retardation which is constant with respect to time is maintained despite an activation, a deactivation, an increase or a reduction of the second braking torque.

In a method step V6, a compensating force is specified on the basis of the second information determined. In this case, the compensating force is specified in such a way that it counteracts a probable adjustment force which, in the operating mode, is applied to the first piston by the force/pressure conversion element. The compensating force preferably compensates the probable adjustment force. In a preferred embodiment, the compensating force is specified, on the basis of the braking torque information, relative to a probable adjustment force, which corresponds to the difference.

In a subsequent method step V7, a second actuator device is activated to provide the specified compensating force to the first piston. In this way, it is possible, for example, to counteract a displacement of a volume of braking medium into the force/pressure conversion element, which is effected during blending in of the time change in the second braking torque, by providing the specified compensating force. As already explained in the above paragraphs, an independently induced adjustment of the actuating element can in this way be prevented.

In the method, it is optionally possible to carry out a further method step V8, in which the boosting force is adapted to the specified compensating force. This is accomplished in such a way, for example, that a sum comprising the compensating force and the boosting force is equal, after respecification of the compensating force, to a sum of the compensating force and the boosting force before respecification of the compensating force.

The method described in the above paragraphs is advantageous especially with recuperative braking, in which part of the kinetic energy of the vehicle is converted into electrical energy. The generator torque, which causes additional braking of the vehicle, is generally dependent on a vehicle speed. Thus the generator torque changes during braking This usually leads to severe fluctuations in the retardation of the vehicle, even with constant actuation of the brake pedal, and these often confuse the driver.

The practice of implementing adaptation of the total braking torque to the generator torque and holding a pedal travel constant by decoupling the actuating element completely from the brake master cylinder is known from the prior art. In this case, the actuating element is connected to a pedal travel simulator, while the pressure buildup in the hydraulic brake system is brought about solely by an externally supplied braking force. However, complete decoupling of the brake pedal from the brake master cylinder is risky since the driver cannot make up for the disappearance of the braking force by means of the driver braking force if the component providing the braking force fails.

The method described in the paragraphs above can also be carried out in the case of mechanical coupling of the actuating element to the brake master cylinder, and thus ensures an improved safety standard for the brake system with braking force multiplication operated by means of the method.

1. A brake booster system for a vehicle brake system, having:
a control device (34), which is designed to specify a boosting force (Fu) on the basis of provided first information relating to a driver braking force (Ff) transmitted to a first piston (12) of the brake system when an actuating element (10) of the brake system is actuated by a driver of the vehicle, and to provide a first control signal (36) on the basis of the specified boosting force (Fu); and
a first actuator device (30), which is designed to receive the first control signal (36) and to apply the boosting force (Fu) corresponding to the first control signal (36) received to a second piston (16) of the brake system, thus enabling a total braking force (Fg) composed of at least the driver braking force (Ff) and the boosting force (Fu) to be transmitted to a force/pressure conversion element (22) of the brake system, enabling a brake pressure (p) corresponding to the total braking force (Fg) to be applied as a first braking torque (Mh) to at least one wheel of the vehicle;
characterized in that the control device (34) is additionally designed to specify a specifiable compensating force (Fa) on the basis of provided second information relating to an operating mode of the brake system, and to provide a second control signal (38) on the basis of the specified compensating force; and
a second actuator device (32) of the brake booster system being designed to receive the second control signal (38) and to apply the compensating force (Fa) corresponding to the second control signal (38) received to the first piston (12) of the brake system.

2. The brake booster system as claimed in claim 1, characterized in that the compensating force (Fa) is specified in such a way that it counteracts a probable adjustment force which, in the operating mode, may be applied to the first piston (12) by the force/pressure conversion element (22).

3. The brake booster system as claimed in claim 2, in which the provided second information comprises braking torque information relating to a time change in a second braking torque (Mz), which can be applied to the at least one wheel in addition to the first braking torque (Mh), and in which the control device (34) is additionally designed to modify the boosting force (Fu), on the basis of the braking torque information, by a difference (D) corresponding to the time change in the second braking torque (Mz).

4. The brake booster system as claimed in claim 3, in which the control device (34) is additionally designed to specify, on the basis of the braking torque information, the compensating force (Fa) relative to a probable adjustment force of the force/pressure conversion element (22) on the first piston (12), which corresponds to the difference (D).

5. The brake booster system as claimed in claim 1, in which the control device (34) is additionally designed to specify the boosting force (Fu) on the additional basis of the specified compensating force (Fa).

6. A brake system having a brake booster system as claimed in claim 1.

7. A vehicle having a brake system as claimed in claim 6.

8. A method for operating a vehicle brake system, the method comprising:
determining first information relating to a driver braking force (Ff) transmitted to a first piston (12) of the brake system when an actuating element (10) of the brake system is actuated by a driver of the vehicle (V1);
specifying a boosting force (Fu) on the basis of the first information determined (V2); and
activating a first actuator device (30) to apply the specified boosting force (Fu) to a second piston (16) of the brake system, with a total braking force (Fg) composed of at least the driver braking force (Ff) and the boosting force (Fu) being transmitted to a force/pressure conversion element (22) of the brake system, and a brake pressure (p) corresponding to the total braking force (Fg) being applied as a first braking torque (Mh) to at least one wheel of the vehicle (V3);
characterized by:
determining second information relating to an operating mode of the brake system (V4);
specifying a specifiable compensating force (Fa) on the basis of the second information determined (V6); and
activating a second actuator device (32) to apply the specified compensating force (Fa) to the first piston (12) (V7).

9. The method as claimed in claim 8, characterized in that the specifiable compensating force is specified in such a way that the compensating force counteracts a probable adjustment force which, in the operating mode, is applied to the first piston (12) by the force/pressure conversion element.

10. The method as claimed in claim 9, in which braking torque information relating to a time change in a second braking torque (Mz), which is applied to the at least one wheel of the vehicle in addition to the first braking torque (Mh), is determined as the second information, and in which the boosting force (Fu) is modified, on the basis of the braking torque information, by a difference (D) corresponding to the time change in the second braking torque (Mz) (V5).

11. The method as claimed in claim 10, in which the compensating force (Fa) is specified, on the basis of the braking torque information, relative to a probable adjustment force of the force/pressure conversion element (22) on the first piston (12), which corresponds to the difference (D).

12. The method as claimed in claim 8, in which the boosting force (Fu) is specified on the additional basis of the specified compensating force (Fa) (V8).
